(19) United States
(12) Patent Application Publication
(10) Pub. No.: US 2019/0339444 A1
(43) Pub. Date: Nov. 7, 2019

(54) DISPLAY DEVICE

(71) Applicant: Innolux Corporation, Chu-Nan (TW)

(72) Inventors: Jef NOTERMANS, Chu-Nan (TW); Jan Meijers, Chu-Nan (TW)

(73) Assignee: Innolux Corporation, Chu-Nan (TW)

(21) Appl. No.: 16/514,054

(22) Filed: Jul. 17, 2019

Related U.S. Application Data
(63) Continuation of application No. 14/981,890, filed on Dec. 28, 2015.

(51) Int. Cl. F21V 8/00

(52) U.S. Cl. CPC G02B 6/0085; G02B 6/005; G02B 6/0055; G02B 6/0088; G02B 6/0056

(57) ABSTRACT

A display device is provided. The display device includes a housing, a backlight module, a shielding member, a cover, and a display panel. The housing includes a bottom sidewall, a top sidewall, and a platform disposed between the bottom sidewall and the top sidewall, and the housing further includes a bottom cavity surrounded by the bottom sidewall and a top cavity surrounded by the top sidewall. The backlight module is disposed in the bottom cavity. The shielding member is disposed on the platform and covering a portion of the backlight module. The cover is disposed on the housing. The display panel is attached to the cover and disposed in the top cavity.

This application is a continuation application of co-pending U.S. application Ser. No. 14/981,890, filed Dec. 28, 2015, the subject matter of which is incorporated herein by reference.

### TECHNICAL FIELD

The disclosure relates in general to a display device, and more particularly to a display device for automobile applications.

### BACKGROUND

Today, display units commonly used in automobile applications are provided with separate backlight units, complicated casing structures, and most importantly, heat spreaders. Different from the display units used in mobile electronic devices, the display units used in automobile applications require good display qualities, excellent heat dissipation performance, and success in passing head impact tests. Therefore, how to provide display units suitable for automobile applications has become a prominent task to the industries.

### SUMMARY

The disclosure is directed to a display device. In the display device of the embodiments, the integral metallic housing is formed integrally and made of aluminum or magnesium, such that it itself is a heat sink and provided with excellent heat dissipation effects without arrangements of additional heat-spreaders.

According to one embodiment of the disclosure, a display device is provided. The display device includes a housing, a backlight module, a shielding member, a cover, and a display panel. The housing includes a bottom sidewall, a top sidewall, and a platform disposed between the bottom sidewall and the top sidewall, and the housing further includes a bottom cavity surrounded by the bottom sidewall and a top cavity surrounded by the top sidewall. The backlight module is disposed in the bottom cavity. The shielding member is disposed on the platform and covering a portion of the backlight module. The cover is disposed on the housing. The display panel is attached to the cover and disposed in the top cavity.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic view of a display device according to an embodiment of the present disclosure;

FIG. 2 is a schematic view of a display device according to another embodiment of the present disclosure;

FIGS. 3-4 are schematic views of display devices according to further embodiments of the present disclosure;

FIGS. 5-13 are partial schematic views of display devices having touch sensor layers according to additional embodiments of the present disclosure; and

FIGS. 14A-14D illustrate a manufacturing method of a display device according to an embodiment of the present disclosure.

### DETAILED DESCRIPTION

According to one embodiment of the disclosure, in the display device, the integral metallic housing is formed integrally and made of aluminum or magnesium, such that it itself is a heat sink and provided with excellent heat dissipation effects without arrangements of additional heat-spreaders.

Detailed descriptions of the embodiments of the disclosure are disclosed below with accompanying drawings. In the accompanying diagrams, the same numeric designations indicate the same or similar components. It should be noted that accompanying drawings are simplified so as to provide clear descriptions of the embodiments of the disclosure, and the following detailed description are exemplary and explanatory only and are not restrictive of the disclosed embodiments as claimed. Anyone who is skilled in the technology field of the disclosure can make necessary modifications or variations to the structures according to the needs in actual implementations.

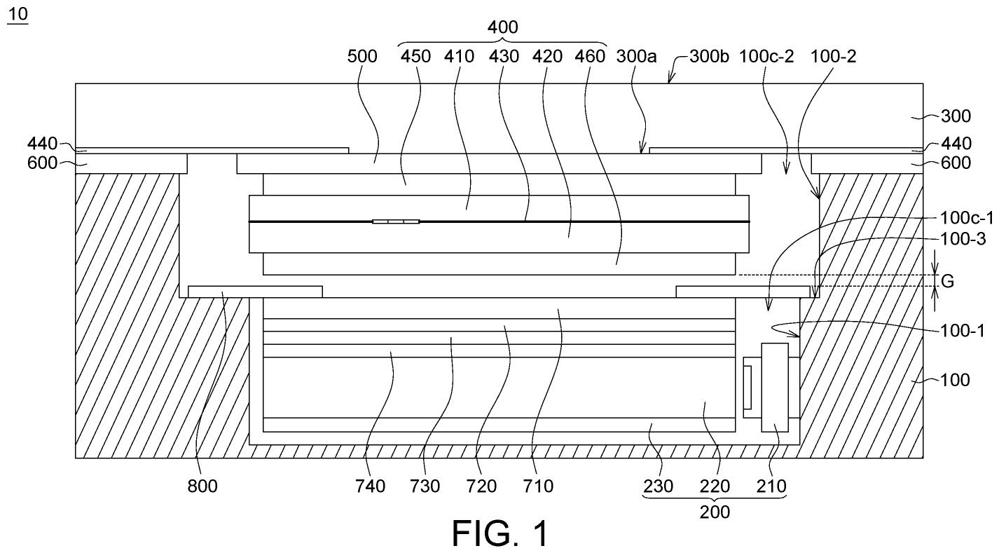

FIG. 1 is a schematic view of a display device 10 according to an embodiment of the present disclosure. As shown in FIG. 1, the display device 10 includes a housing 100, a backlight module 200, a shielding member 800, a cover 300, and a display panel 400. The housing 100 includes a bottom sidewall 100-1, a top sidewall 100-2, and a platform 100-3 disposed between the bottom sidewall 100-1 and the top sidewall 100-2. The housing 100 further includes a bottom cavity 100c-1 surrounded by the bottom sidewall 100-1 and a top cavity 100c-2 surrounded by the top sidewall 100-2. The backlight module 200 is disposed in the bottom cavity 100c-1. The shielding member 800 is disposed on the platform 100-3 and covers a portion of the backlight module 200. The cover 300 is disposed on the housing 100. The display panel 400 is attached to the cover 300 and disposed in the top cavity 100c-2.

In the embodiment, the housing 100 is such as an integral housing, preferably an integral metallic housing, which is formed integrally. In the embodiment, the cover 300 is such as a transparent substrate.

In the embodiment, the housing 100 may include aluminum, magnesium, or an alloy thereof. That is, in the embodiment, the housing 100 is formed integrally and made of aluminum, magnesium, or the alloy of aluminum and magnesium. In some embodiments, the housing 100 may be made integrally by a CNC milling process, such that the tolerance of the size deviation of the structural features may be as small as within ±0.03 mm. In addition, the housing 100 made of aluminum, magnesium, or the alloy thereof itself is a heat sink and provided with excellent heat dissipation effects without arrangements of additional heat-spreaders.

In the embodiment, the display panel 400 may be a liquid crystal display panel, an organic light emitting diode display, or an inorganic light emitting diode display. The display device 10 may further include a construction bracket (not shown in drawings) made of aluminum or magnesium covering the housing 100.

In the embodiment, the cover 300 may be a cover window made of a plastic, ceramic or glass material. For example, the cover 300 may be a cover glass or a safety glass having a thickness of about 400-1100 μm.

As shown in FIG. 1, the display device 10 may further include a first adhesive 500. The first adhesive 500 is formed on the cover 300 for adhering the display panel 400 to the cover 300. In the embodiments, the first adhesive 500 may be an optical adhesive layer, for example, including an optical clear adhesive or an optical clear resin.

As shown in FIG. 1, the display device 10 may further include a second adhesive 600. The second adhesive 600 is disposed on the housing 100 for adhering the cover 300 to the housing 100. While the housing 100 is made integrally by a CNC milling process in the embodiment, the surfaces of the housing 100 is flat and uniform; in such case, the housing 100 is adhered to the cover 300 by the second adhesive 600, maintaining a flat and uniform contact interface between the housing 100 and the cover 300, resulting in a decrease of MURA effects. In the embodiment, the second adhesive 600 may be a double-sided adhesive (DSA) layer.

As shown in FIG. 1, the backlight module 200 may include a backlight source 210, a light guide 220, and an optical film 710. The light guide 220 is disposed adjacent to the backlight source 210. The optical film 710 is disposed on the light guide 220.

As shown in FIG. 1, the back light module 200 may further include a reflector 230. The reflector 230 is disposed at a bottom side of the light guide 220.

In the embodiment, the backlight source 210 may be a LED light source, such as a LED flexible printed circuit assembly (LED-FPCA) or a LED printed circuit board assembly (LED-PCBA). The backlight source 210 may be arranged adjacent to a side surface of the light guide 220. In an embodiment, the backlight source 210 may be attached onto a sidewall-cavity of the housing 100, such that the heat produced by the backlight source 210 may be dispensing toward the housing 100.

In the embodiments, as shown in FIG. 1, the optical film 710 is disposed between the display panel 400 and the backlight module 200. In the embodiment as shown in FIG. 1, the display device 10 includes four optical films 710, 720, 730 and 740. One of the four optical films 710, 720, 730 and 740 may include a Quantum dot enhancement film.

In the embodiment, the shielding member 800 may be a single sided adhesive (SSA) layer for adhering the optical film 710 to the housing 100. The shielding member 800 may have a thickness of about 30-250 μm. As shown in FIG. 1, the display panel 400 and the shielding member 800 are separated from each other by a gap G. In the embodiment, the gap G may be very small such as about 30-45 μm, and such small gap G provides improvements on viewing angle performance as well as on luminance uniformity under certain viewing angle. Specifically, the small gap G between the display panel 400 and the shielding member 800 can further decrease “push-water-ripple” effects and be advantageous to head impact test (HIT) tests.

In addition, the shielding member 800 has a rim shape sealing the edge of the optical film 710, avoiding possible light leakage and/or visibility of optical films under certain viewing angle.

As shown in FIG. 1, the display panel 400 is attached to a first surface 300a of the cover 300. In the embodiment, the display panel 400 may include a first substrate 410, a second substrate 420, and a display layer 430 disposed between the first substrate 410 and the second substrate 420. In the embodiment, the first substrate 410 is a color filter substrate, the second substrate 420 is a thin film transistor substrate, and the display layer 430 is a liquid crystal layer or an inorganic light emitting diode layer. While in other embodiments, the first substrate 410 is a transparent substrate, the second substrate 420 is a thin film transistor substrate, and the display layer 430 is an organic light emitting diode layer or an inorganic light emitting diode layer. In the embodiment, the display panel 400 further includes a top polarizer 450 and a bottom polarizer 460.

In the embodiment, as shown in FIG. 1, the display layer 430 may have a display active area defined by the black matrix 440, and the cover 300 may have a viewing area defined by the black matrix 440. The display panel 400 is laminated onto the cover 300 by aligning the display active area with the viewing area in a center-to-center fashion.

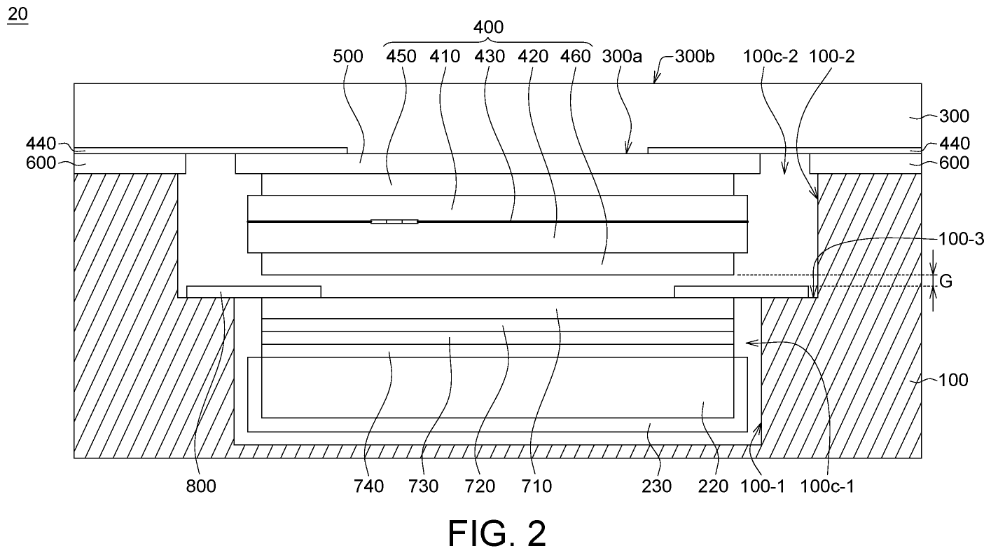

FIG. 2 is a schematic view of a display device according to another embodiment of the present disclosure. The elements in the present embodiment sharing similar or the same labels with those in the previous embodiment are similar or the same elements, and the description of which is omitted. The display device 20 as shown in the present embodiment is different from the display device 20 in the previous embodiment mainly in the design of the reflector 230.

In the present embodiment, the reflector 230 has a bending structure surrounding three lateral sides and one bottom side of the light guide 220, except one lateral side which faces the backlight source 210 (not shown in FIG. 2), for improving the performance of the backlight module 200.

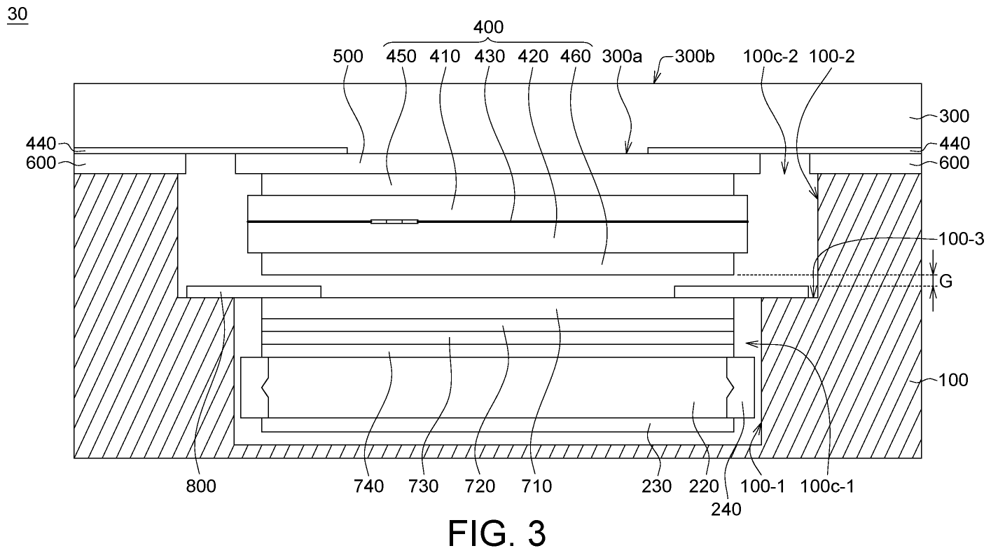

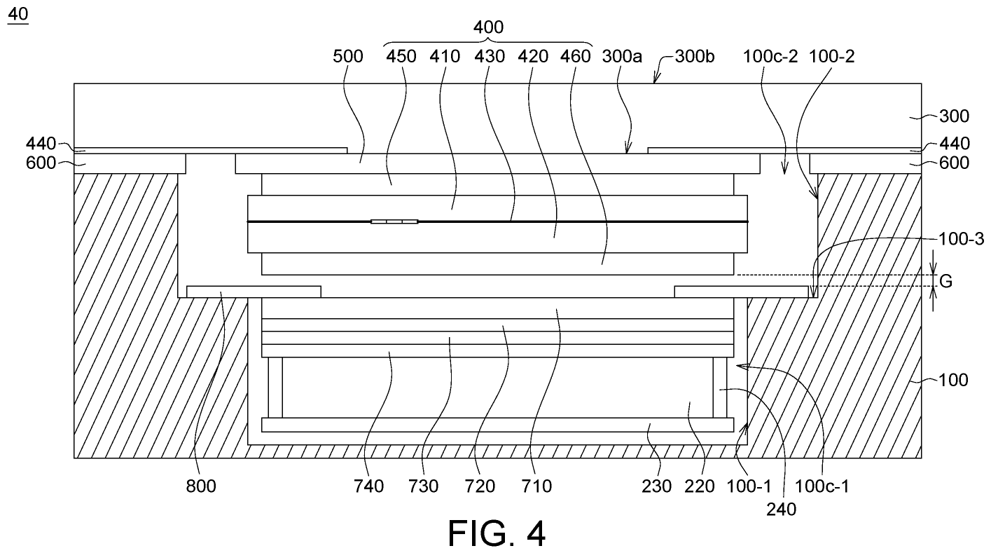

FIGS. 3-4 are schematic views of display devices according to further embodiments of the present disclosure. The elements in the present embodiment sharing similar or the same labels with those in the previous embodiment are similar or the same elements, and the description of which is omitted.

In the display devices 30 and 40 as shown in FIGS. 3-4, the backlight module 200 may further include a light shielding material 240, and the light shielding material 240 is disposed on at least one lateral side of the light guide 220. In the embodiments as shown in FIGS. 3-4, the light shielding material 240 is disposed on three lateral sides of the light guide 220, except one lateral side toward the backlight source 210.

In the embodiment as shown in FIG. 3, the light shielding material 240 is formed as a casing overmolded with the light guide 220 or separately incorporated with the light guide 220. The casing is made of any suitable opaque material. In the embodiment as shown in FIG. 4, the light shielding material 240 is formed by painting or coating a light shielding material on three lateral sides of the light guide 220.

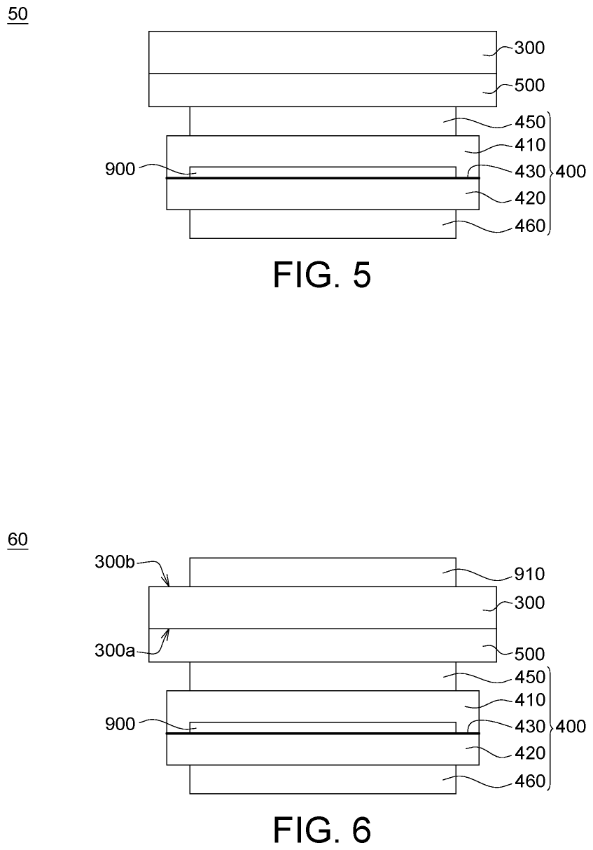

FIGS. 5-13 are partial schematic views of display devices having touch sensor layers according to additional embodiments of the present disclosure. The elements in the present embodiment sharing similar or the same labels with those in the previous embodiment are similar or the same elements, and the description of which is omitted.

It is to be noted that the display devices described hereinafter as shown in FIGS. 5-13 all include the housing 100, the backlight module 200, the cover 300, and the display panel 400 as described in the previous embodiments. While the housing 100 and the backlight module 200 is omitted from the figures for the sake of simplicity. For example, the cover 300 is disposed on the housing 100, the display panel 400 is attached to the cover 300 and disposed in the top cavity 100c-1 of the housing 100, and the backlight module 200 is disposed in the bottom cavity 100c-2 of the housing. In other words, the additional structural features described in the following embodiments can be applied in any of the aforementioned structures generating additional embodiments of the present disclosure.

In the embodiment as shown in FIG. 5, the display device 50 further includes a touch sensor layer 900 disposed between the first substrate 410 and the second substrate 420. In other words, the touch sensor layer 900 of the display device 50 is installed in the display panel 400; that is, a full in-cell touch sensor. In addition, the display panel 400 is adhered to the cover 300 with the first adhesive 500.

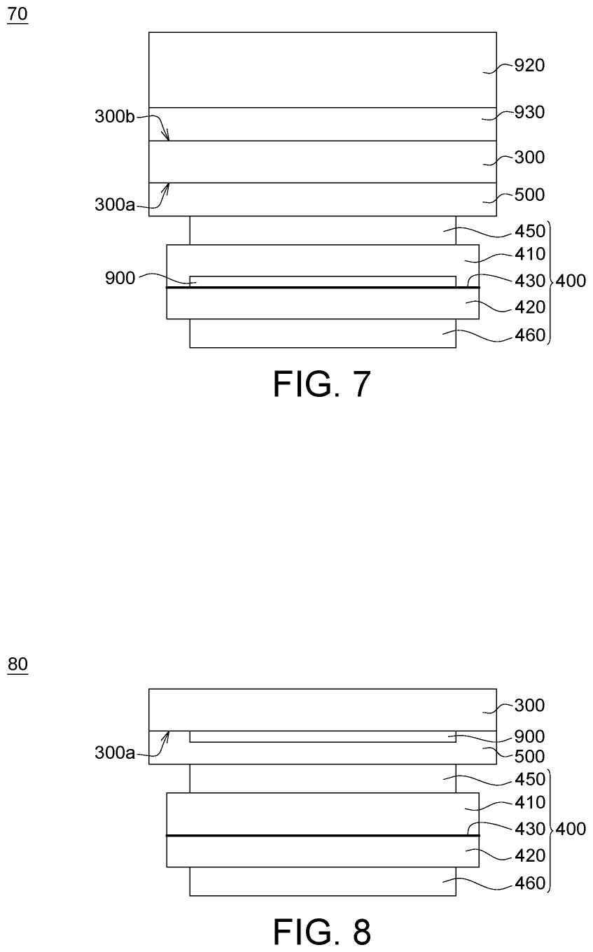

In the embodiment as shown in FIG. 6, the display device 60 further includes a touch sensor layer 900 disposed between the first substrate 410 and the second substrate 420 and a top polarizer 910. The top polarizer 910 is disposed on a second surface 300b of the cover 300, and the second surface 300b is opposite to the first surface 300a. The display device 60 may further include a PET film (not shown in drawings) disposed on the top polarizer 910. In addition, the display panel 400 is adhered to the first surface 300a of the cover 300 with the first adhesive 500.

In the embodiments, the arrangement of the top polarizer 910 on the cover 300, which may be a cover glass, can prevent particles or splinters of broken cover glass under impact from spreading all over, and this is particularly useful in automobile applications.

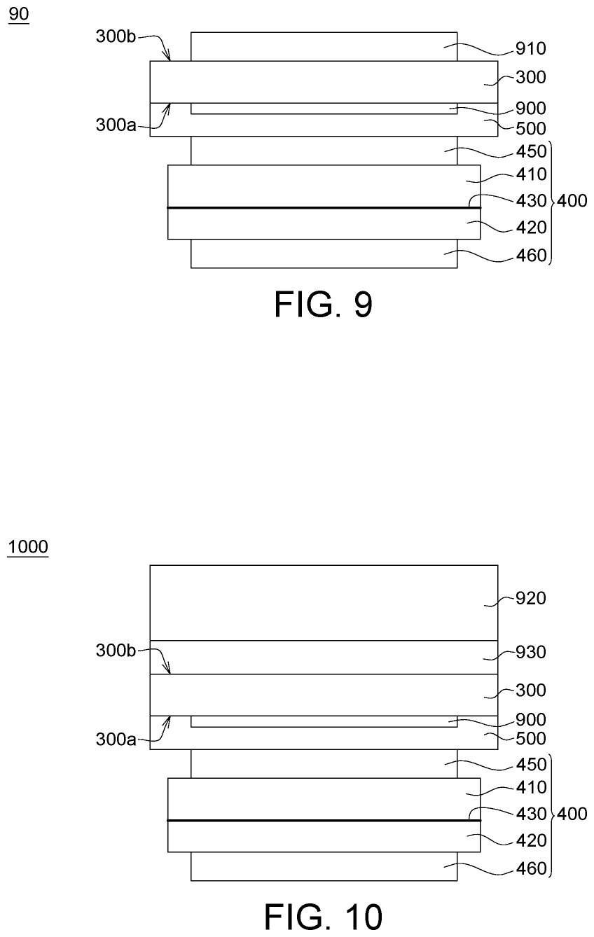

In the embodiment as shown in FIG. 7, the display device 70 further includes a touch sensor layer 900 disposed between the first substrate 410 and the second substrate 420, a safety cover 920, and an adhesive layer 930. The safety cover 920 is disposed on a second surface 300b of the cover 300, and the second surface 300b is opposite to the first surface 300a. The adhesive layer 930 is disposed between the safety cover 920 and the cover 300. In the embodiment, the adhesive layer 930 may be PVB (polyvinyl butyral).

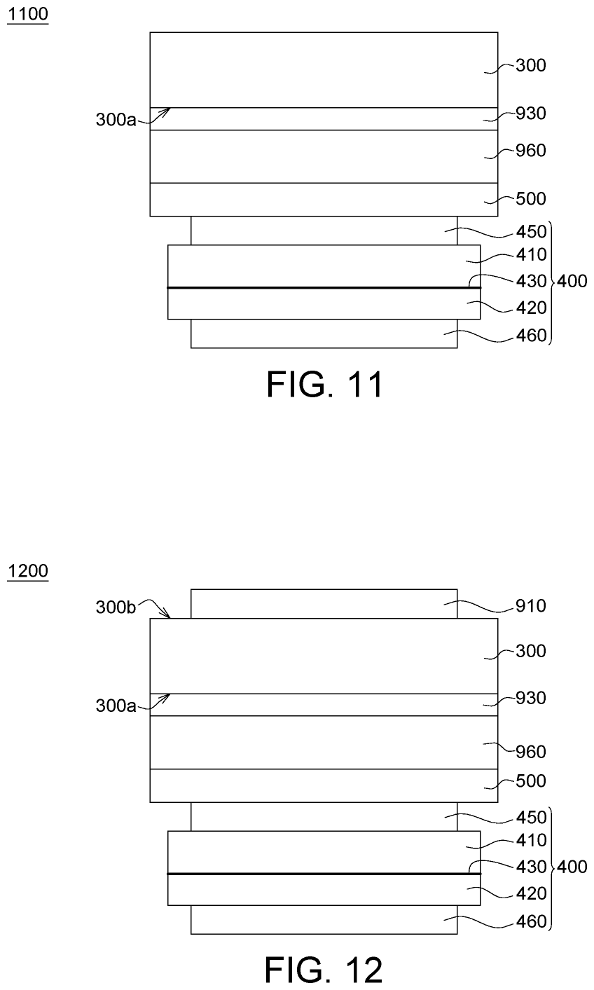

In the embodiment as shown in FIG. 8, the display panel 400 is attached to a first surface 300a of the cover 300, and the display device 80 further includes a touch sensor layer 900, and the touch sensor layer 900 is disposed between the display panel 400 and the cover 300. In other words, the cover 300 is integrated with the touch sensor layer 900 on the first surface 300a. In some embodiments, the first surface 300a may be performed with specific surface treatment for integrating the touch sensor layer 900 thereon.

In the present embodiment, as shown in FIG. 8, the touch sensor layer 900 is disposed on the first surface 300a of the cover 300.

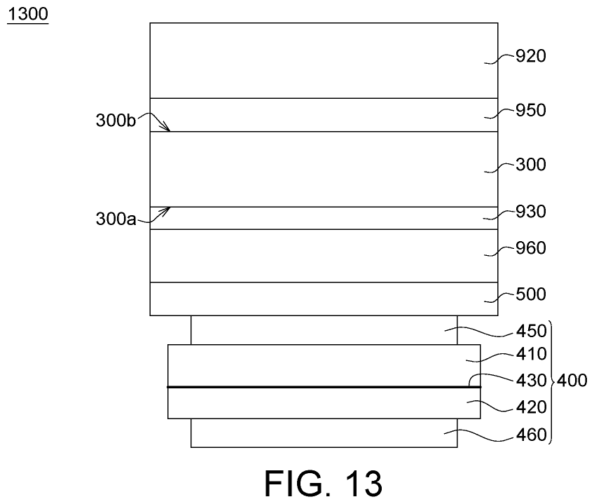

In the embodiment as shown in FIG. 9, the display panel 400 is attached to a first surface 300a of the cover 300, and the display device 90 further includes a touch sensor layer 900 disposed on the first surface 300a of the cover 300. A top polarizer 910 is disposed on the second surface 300b of the cover 300, and the second surface 300b is opposite to the first surface 300a. The display device 90 may further include a PET film (not shown in drawings) disposed on the top polarizer 910.

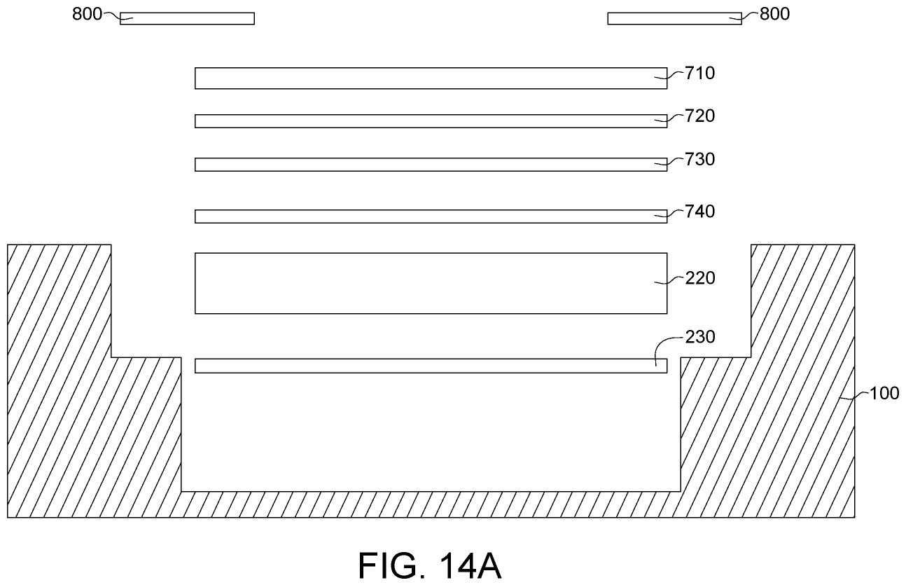

In the embodiment as shown in FIG. 10, the display panel 400 is attached to a first surface 300a of the cover 300, the display device 1000 further includes a touch sensor layer 900, and the touch sensor layer 900 is disposed on the first surface 300a of the cover 300. In other words, the touch sensor layer 900 is integrated onto the cover 300.

As shown in FIG. 10, the display device 1000 further includes a safety cover 920 and an adhesive layer 930. The safety cover 920 is disposed on a second surface 300b of the cover 300, and the adhesive layer 930 is disposed between the safety cover 920 and the cover 300.

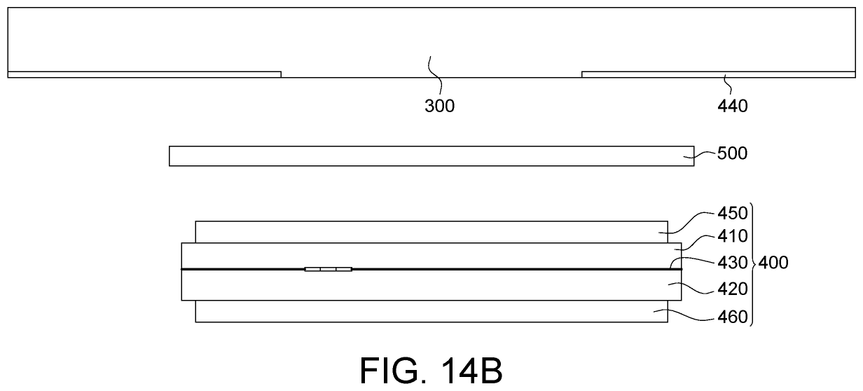

In the embodiment as shown in FIG. 11, the display device 1100 further includes a touch panel 960. The touch panel 960 is disposed between the display panel 400 and the cover 300, and the touch panel 960 is attached to a first surface 300a of the cover 300. The display device 1100 may further include an adhesive layer 930, and the touch panel 960 is adhered to the cover 300 with the adhesive layer 930.

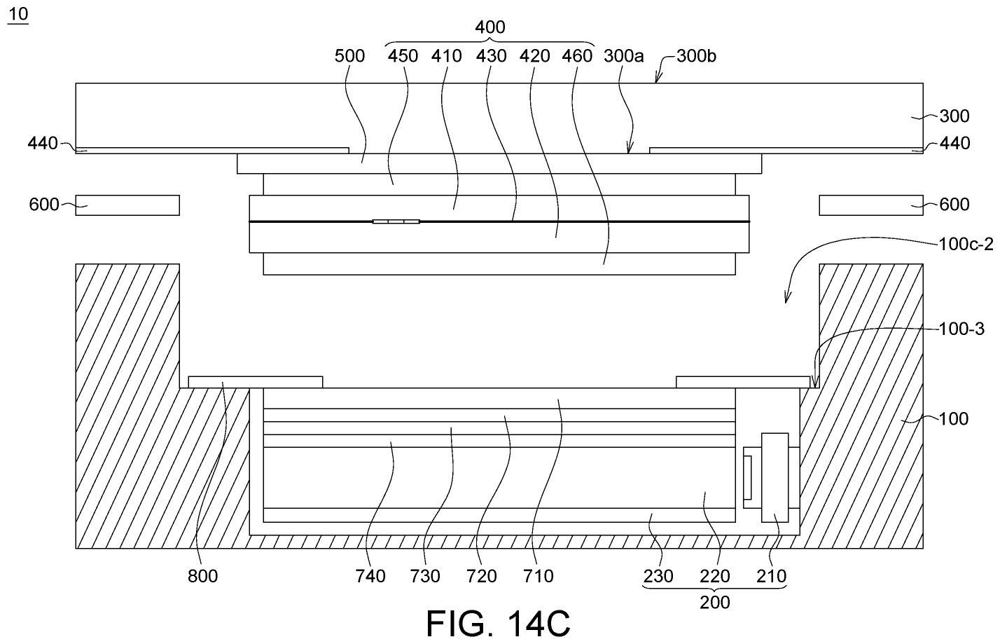

In the embodiment as shown in FIG. 12, the display device 1200 further includes a touch panel 960 disposed between the display panel 400 and the cover 300, and the touch panel 960 is attached to a first surface 300a of the cover 300. The display device 1200 further includes a top polarizer 910 disposed on a second surface 300b of the cover 300, the second surface 300b being opposite to the first surface 300a. Additionally, the touch panel 960 is disposed between the adhesive layer 930 and the first adhesive 500. The display device 1200 may further include a PET film (not shown in drawings) disposed on the top polarizer 910.

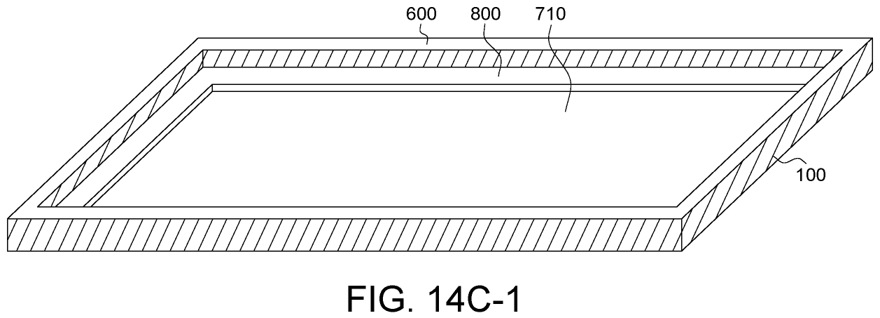

In the embodiment as shown in FIG. 13, the display device 1300 further includes a touch panel 960 disposed between the display panel 400 and the cover 300, and the touch panel 960 is attached to a first surface 300a of the cover 300.The display device 1300 further includes a safety cover 920 and an adhesive layer 950. The safety cover 920 is disposed on a second surface 300b of the cover 300, the second surface 300b being opposite to the first surface 300a. The adhesive layer 950 is disposed between the cover 300 and the safety cover 920.

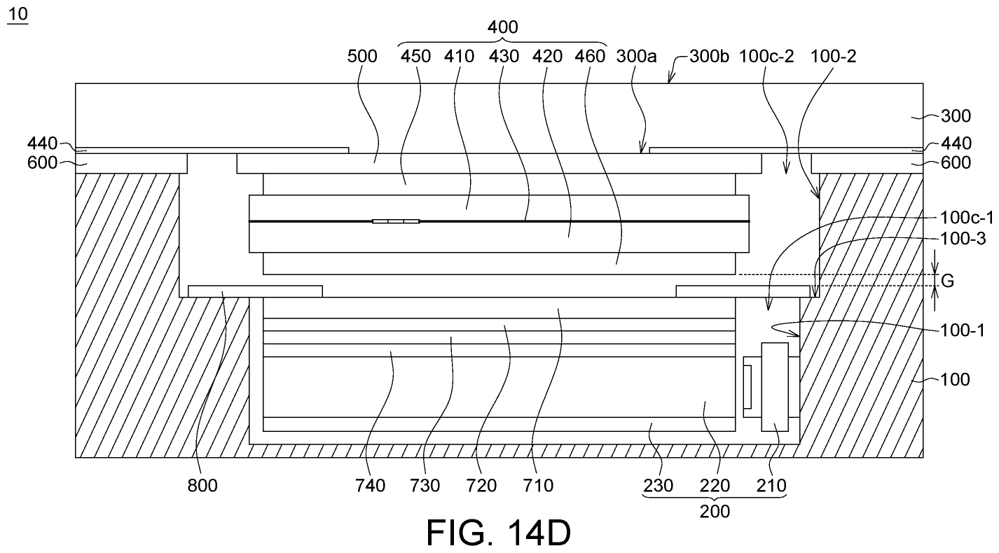

FIGS. 14A-14D illustrate a manufacturing method of a display device according to an embodiment of the present disclosure. The elements in the present embodiment sharing similar or the same labels with those in the previous embodiment are similar or the same elements, and the description of which is omitted.

Referring to FIG. 14A, the optical film 710 and/or the optical films 720-740 are assembled to the backlight module 200 including the light guide 220 and the reflector 230, and then the optical film 710 and/or the optical films 720-740 along with the backlight module 200 are attached to the housing 100 by both adhering to the shielding member (SSA layer) 800.

Referring to FIG. 14B, the display panel 400 is adhered to the cover 300 via the first adhesive 500.

Referring to FIGS. 14C and 14C-1, the assemblies from FIG. 14A and 14B are assembled to each other via the second adhesive 600. As shown in FIG. 14C-1, the shielding member 800 and the second adhesive 600 both have a rim shape. The second adhesive 600 is disposed on the top of the housing 100 surrounding the edge of the top cavity 100c-2. The shielding member 800 is disposed around the top edge of the optical film 710 for adhering the top edge of the optical film 710 to the platform 100-3 of the housing 100.

Referring to FIG. 14D, the display device 10 as shown in FIG. 1 is assembled.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display device, comprising:
a housing including a bottom sidewall, a top sidewall, and a platform disposed between the bottom sidewall and the top sidewall, the housing further including a bottom cavity surrounded by the bottom sidewall and a top cavity surrounded by the top sidewall;
a backlight module disposed in the bottom cavity, wherein the backlight module comprises a backlight source and an optical film disposed in the bottom cavity;
a shielding member disposed on the platform and covering a portion of the backlight module, wherein a surface of the shielding member is in contact with the platform and the optical film for adhering the optical film to the housing, and the backlight source is attached on the bottom sidewall and separated from the surface of the shielding member by a gap;
a cover disposed on the housing;
a display panel attached to the cover and disposed in the top cavity; and
a black matrix overlapping at least a portion of the display panel, the shielding member, and the backlight source.

2. The display device according to claim 1, further comprising a first adhesive for adhering the display panel to the cover.

3. The display device according to claim 1, further comprising a second adhesive disposed on the housing for adhering the cover to the housing.

4. The display device according to claim 1, wherein the housing is an integral housing.

5. The display device according to claim 1, wherein the housing is a metallic housing comprises aluminum, magnesium, or an alloy thereof.

6. The display device according to claim 1, wherein the backlight module further comprises:
a light guide disposed adjacent to the backlight source, wherein the optical film is disposed on the light guide.

7. The display device according to claim 6, wherein the backlight module further comprises a reflector disposed at a bottom side of the light guide.

8. The display device according to claim 7, wherein the reflector covers at least two lateral sides of the light guide.

9. The display device according to claim 6, wherein the backlight module further comprises a light shielding material disposed on at least one lateral side of the light guide.

10. The display device according to claim 1, wherein the shielding member is a single sided adhesive.

11. The display device according to claim 1, wherein the display panel and the shielding member are separated from each other by a gap.

12. The display device according to claim 1, wherein the display panel is attached to a first surface of the cover, and the display panel comprises a first substrate, a second substrate, and a display layer disposed between the first substrate and the second substrate, and the display device further comprises a touch sensor layer disposed between the first substrate and the second substrate.

13. The display device according to claim 12, further comprising:
a top polarizer disposed on a second surface of the cover, the second surface being opposite to the first surface.

14. The display device according to claim 12, further comprising:
a safety cover disposed on a second surface of the cover, the second surface being opposite to the first surface; and
an adhesive layer disposed between the cover and the safety cover.

15. The display device according to claim 1, wherein the display panel is attached to a first surface of the cover, and the display device further comprises:
a touch sensor layer disposed on the first surface of the cover.

16. The display device according to claim 15, further comprising:
a top polarizer disposed on a second surface of the cover, the second surface being opposite to the first surface.

17. The display device according to claim 15, further comprising:
a safety cover disposed on a second surface of the cover, the second surface being opposite to the first surface; and
an adhesive layer disposed between the cover and the safety cover.

18. The display device according to claim 1, further comprising:
a touch panel disposed between the display panel and the cover, the touch panel being attached to a first surface of the cover.

19. The display device according to claim 18, further comprising:
a top polarizer disposed on a second surface of the cover, the second surface being opposite to the first surface.

20. The display device according to claim 18, further comprising:
a safety cover disposed on a second surface of the cover, the second surface being opposite to the first surface; and
an adhesive layer disposed between the cover and the safety cover.
